(19) United States
(12) Patent Application Publication
(10) Pub. No.: US 2023/0311575 A1
(43) Pub. Date: Oct. 5, 2023

(54) TIRE

(71) Applicant: Sumitomo Rubber Industries, Ltd., Kobe-shi (JP)

(72) Inventor: Masahiro YAO, Kobe-shi (JP)

(73) Assignee: Sumitomo Rubber Industries, Ltd., Kobe-shi (JP)

(21) Appl. No.: 18/104,860

(22) Filed: Feb. 2, 2023

(30) Foreign Application Priority Data
Mar. 31, 2022 (JP) 2022-060431

(51) Int. Cl. B60C 11/03; B60C 11/12

(52) U.S. Cl. CPC B60C 11/0309; B60C 11/1236; B60C 11/1204; B60C 2011/1254

(57) ABSTRACT

The tire has first crown blocks each including a ground contacting surface and a block wall surface. The block wall surface includes a first block wall surface adjacent to crown grooves and a second block wall surface adjacent to a first shoulder circumferential groove. The first block wall surface is provided with a chamfered portion on the ground contacting surface side in a range of 50% or more of a length of the first block wall surface. The second block wall surface is either not provided with the chamfered portion or provided with the chamfered portion in a range of less than 50% of a length of the second block wall surface.

### RELATED APPLICATIONS

This application claims the benefit of foreign priority to Japanese Patent Applications No. JP2022-060431, filed Mar. 31, 2022, which are incorporated by reference in its entirety.

### FIELD OF THE INVENTION

The present disclosure relates to a tire.

### BACKGROUND OF THE INVENTION

Japanese Unexamined Patent Application Publication No. 2021-62655 has described a tire having a tread portion provided with a plurality of crown blocks. Each of the crown blocks includes a chamfered portion surrounding the entire circumference of a ground contacting surface thereof, and a stepped portion provided inside the chamfered portion in a tire radial direction.

### SUMMARY OF THE INVENTION

In recent years, there has been a demand for further improvement in on-snow performance while maintaining anti-wear performance for tires, especially tires for SUVs.

The present disclosure was made in view of the above, and a primary object thereof is to provide a tire capable of further improving the on-snow performance while maintaining the anti-wear performance.

The present disclosure is a tire including a tread portion wherein the tread portion includes a first tread edge, a first shoulder circumferential groove adjacent to the first tread edge and arranged between the first tread edge and a tire equator, a plurality of crown blocks arranged inside the first shoulder circumferential groove in a tire axial direction, and a plurality of crown grooves arranged axially inside the first shoulder circumferential groove to separate the crown blocks from each other,
the crown blocks include a plurality of first crown blocks adjacent to the first shoulder circumferential groove,
each of the first crown blocks includes a ground contacting surface and a block wall surface extending inward in a tire radial direction from the ground contacting surface,
the block wall surface includes a first block wall surface adjacent to one of the crown grooves and a second block wall surface adjacent to the first shoulder circumferential groove,
the first block wall surface is provided with a chamfered portion on the ground contacting surface side in a range of 50% or more of a length of the first block wall surface measured along the ground contacting surface, and
the second block wall surface is either not provided with the chamfered portion on the ground contacting surface side or provided with the chamfered portion on the ground contacting surface side in a range of less than 50% of a length of the second block wall surface measured along the ground contacting surface.

It is possible that the tire of the present disclosure further improves the on-snow performance while maintain the anti-wear performance by adopting the above-mentioned configuration.

### BRIEF DESCRIPTION OF THE DRAWINGS

FIG. 1 is a plan view of a tread portion according to an embodiment of the present disclosure.

FIG. 2 is a plan view of one of first crown blocks of FIG. 1.

FIG. 3A is an A-A cross sectional view of FIG. 1.

FIG. 3B is a B-B cross sectional view of FIG. 1.

FIG. 4 is a plan view of one of laterally long blocks.

FIG. 5 is a plan view of one of second crown blocks of FIG. 1.

FIG. 6 is a C-C cross sectional view of FIG. 1.

FIG. 7 is a plan view of shoulder blocks.

FIG. 8 is a D-D cross sectional view of FIG. 7.

FIG. 9 is a plan view of the tread portion according to another embodiment.

### DETAILED DESCRIPTION OF THE INVENTION

An embodiment of the present disclosure will now be described below in conjunction with accompanying drawings.

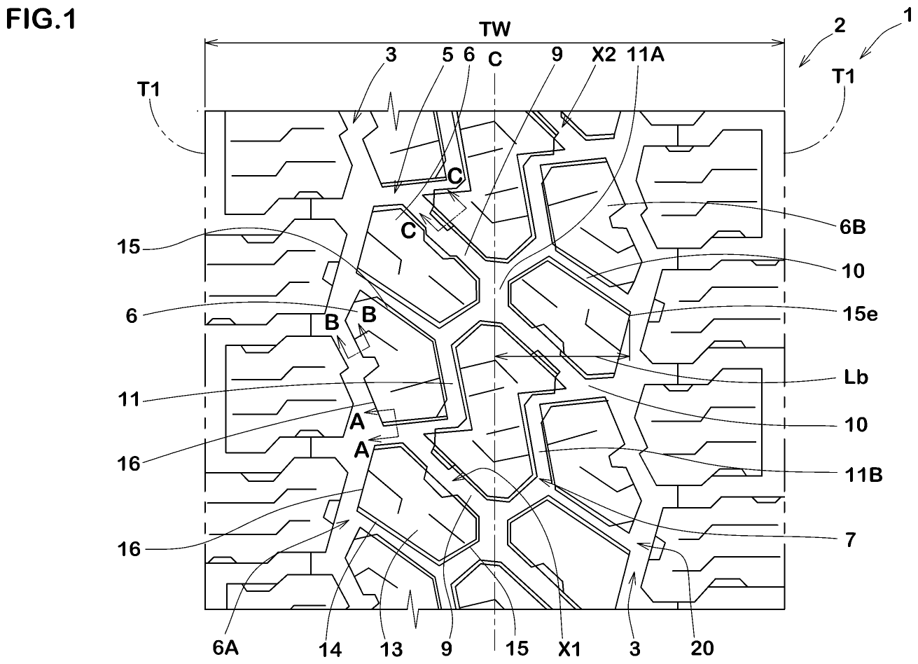

FIG. 1 is a developed plan view of a tread portion 2 of a tire 1 of the present embodiment. The present disclosure is applied to pneumatic tires for SUVs suitable for running on rough terrain, for example. The present disclosure can also be applied to pneumatic tires for passenger cars and for heavy duty, and non-pneumatic tires configured not to be filled with compressed air.

As shown in FIG. 1, the tread portion 2 of the present embodiment includes a first tread edge T1, a first shoulder circumferential groove 3, a plurality of crown blocks 5 and a plurality of crown grooves 9. The first shoulder circumferential groove 3 is arranged between the first tread edge T1 and a tire equator (C) and adjacent to the first tread edge T1. The crown blocks 5 are arranged inside the first shoulder circumferential groove 3 in a tire axial direction. The crown grooves 9 are arranged axially inside the first shoulder circumferential groove 3 and demarcate the crown blocks 5.

The crown blocks include a plurality of first crown blocks 6 adjacent immediately to the first shoulder circumferential groove 3. Each of the first crown blocks 6 includes a ground contacting surface 13 and a block wall surface 14 extending radially inward from the ground contacting surface 13.

The block wall surface 14 includes a first block wall surface 15 adjacent to (so as to face) one of the crown grooves 9 and a second block wall surface 16 adjacent to (so as to face) the first shoulder circumferential groove 3. In other words, the second block wall surface 16 is arranged axially outside the first block wall surface 15.

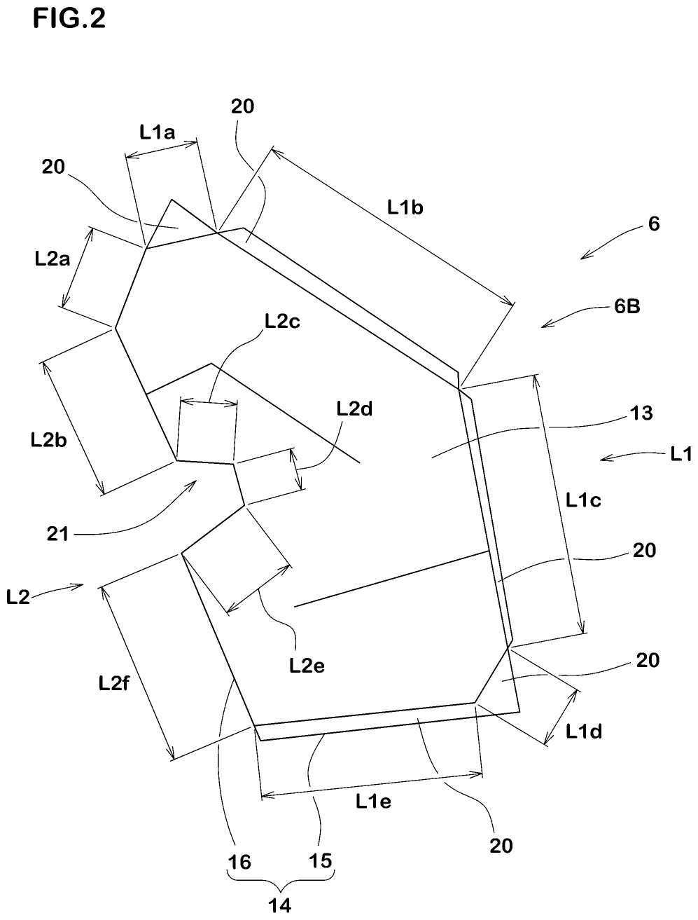

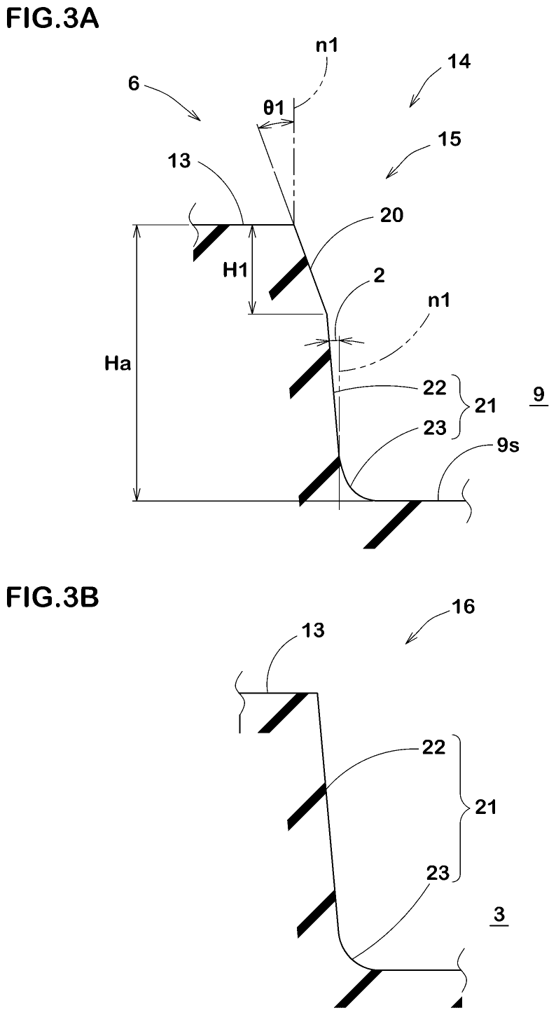

FIG. 2 is an enlarged view of one of the first crown blocks 6. FIG. 3A is an A-A cross-sectional view of FIG. 1 and FIG. 3B is a B-B cross-sectional view of FIG. 1. As shown in FIGS. 2, 3A, and 3B, the first block wall surface 15 is provided with a chamfered portion 20 extending 50% or more of a length L1 of the first block wall surface 15 measured along the ground contacting surface 13 (measured along the contour of the ground contacting surface 13 in this case, the same applies hereinafter). In the present specification, the length L1 of the first block wall surface 15 is defined as the sum of the lengths of the linearly extending portions, and in the case of the first crown block shown in FIG. 2, the length L1 is the sum of a length (L1a), a length (L1b), a length (L1c), a length (L1d), and a length (L1e). The first block wall surface 15 configured as such has great rigidity and thus enhances the basic anti-wear performance of the block. The second block wall surface 16 is not provided with the chamfered portion on the ground contacting surface 13 side or provided with the chamfered portion 20 arranged on the ground contacting surface 13 side and extending less than 50% of a length L2 (not shown) of the second block wall surface 16 measured along the ground contacting surface 13. The length L2 of the second block wall surface 16 is also defined by the sum of the lengths of the linearly extending portions, and in the case of the first crown block 6 shown in FIG. 2, the length L2 is the sum of a length (L2a), a length (L2b), a length (L2c), a length (L2d), a length (L2e), and a length (L2f). The second block wall surface 16 configured as such exerts a high edge effect on snowy roads and thus improves the on-snow performance. Further, since a relatively small ground contact pressure acts on the second block wall surface 16, wear is suppressed even if the chamfered portion 20 is not provided. Therefore, the tire 1 of the present embodiment can further improve the on-snow performance while maintaining the anti-wear performance. Furthermore, the tire 1 configured as such has excellent steering stability performance and excellent wet performance. The second block wall surface 16 of the present embodiment does not have a chamfered portion formed on the ground contacting surface 13 side, therefore, it exerts high on-snow performance.

In order to improve the anti-wear performance, the first block wall surface 15 is provided with the chamfered portion 20 in the range of 70% or more, more preferably in the range of 85% or more of the length L1 of the first block wall surface 15. In the present embodiment, the first block wall surface 15 has the chamfered portion 20 formed in the range of 100% of the length L1 of the first block wall surface 15. In a tread plan view, the first block wall surface 15 extends in a zigzag shape.

An angle θ1 of the chamfered portion 20 with respect to a normal line (n1) of the ground contacting surface 13 is preferably 10 degrees or more, more preferably 15 degrees or more, and preferably 30 degrees or less, and even more preferably 25 degrees or less. Since the angle θ1 of the chamfered portion 20 is 10 degrees or more, the anti-wear performance is maintained high. In addition, since drainage property is enhanced, the wet performance is improved. Since the angle θ1 of the chamfered portion 20 is 30 degrees or less, high on-snow performance is exerted.

The first block wall surface 15 includes a wall surface main body 21 extending inward in the tire radial direction from the chamfered portion 20. The wall surface main body 21 in the present embodiment includes a linear portion 22 extending linearly in the tire radial direction over the entire length thereof, and an arcuate portion 23 extending in an arc shape to connect the linear portion 22 and a groove bottom (9s) of one of the crown grooves 9 adjacent thereto. It should be noted that the wall surface main body 21 is not limited to such an aspect, and for example, the wall surface main body 21 may include a large arcuate portion (not shown) having a larger radius of curvature than the arcuate portion 23 and connecting the arcuate portion 23 with the chamfered portion 20.

A difference (θ1−θ2) between the angle θ1 of the chamfered portion 20 and an angle θ2 of the wall surface main body 21 with respect to the normal line (n1) is preferably 10 degrees or more, more preferably 15 degrees or more, and preferably 30 degrees or less, and more preferably 25 degrees or less. Since the difference (θ1−θ2) is 10 degrees or more, the rigidity of the first crown blocks 6 can be maintained high, thereby, the anti-wear performance is maintained. Since the difference (θ1−θ2) is 30 degrees or less, the wall surface main body 21 secures the shearing force on a snowy road surface, therefore, the on-snow performance is improved. The angle θ2 of the wall surface main body 21 is specified by the angle of the linear portion 22.

A length H1 in the tire radial direction of the chamfered portion 20 is preferably 20% or more, more preferably 25% or more, and preferably 40% or less, more preferably 35% or less of a length (Ha) in the tire radial direction of the block wall surface 14. Since the length H1 of the chamfered portion 20 is 20% or more of the length (Ha) of the block wall surface 14, the anti-wear performance is maintained. Since the length H1 of the chamfered portion 20 is 40% or less of the length (Ha) of the block wall surface 14, the improving effect of the on-snow performance is ensured.

As shown in FIG. 3B, the second block wall surface 16 in the present embodiment is formed by the wall surface main body 21, which includes the linear portion 22 and the arcuate portion 23. The second block wall surface 16 is formed only by the wall surface main body 21 at 100% of the length L2 of the second block wall surface 16 measured along the ground contacting surface 13, for example.

As shown in FIG. 1, the tread portion 2 of the present embodiment adopts a point-symmetrical pattern with an arbitrary point on the tire equator (C) as the center of symmetry. Thereby, the tread portion 2 of the present embodiment is provided with a pair of the first tread edges T1 and a pair of the first shoulder circumferential grooves 3. It should be noted that the tread portion 2 may be configured as a line-symmetrical pattern with the tire equator (C) as the axis of symmetry, for example. Further, the tread portion 2 is not limited to the point-symmetric pattern or the line-symmetric pattern.

The first tread edges T1 are defined as the outermost ground contact positions in the tire axial direction when the tire 1 in a standard state is in contact with a flat surface with zero camber angle by being loaded with a standard tire load. A tread width TW is the distance in the tire axial direction between the first tread edges T1.

The term “standard state” refers to a state in which the tire 1 is mounted on a standard rim (not shown), inflated to a standard inner pressure, and loaded with no tire load. Dimensions of various parts of the tire 1 are the values measured in this standard state Unless otherwise specified.

The term “standard rim” refers to a wheel rim specified for the concerned tire by a standard included in a standardization system on which the tire is based, for example, the “normal wheel rim” in JATMA, “Design Rim” in TRA, and “Measuring Rim” in ETRTO.

The term “standard inner pressure” refers to air pressure specified for the concerned tire by a standard included in a standardization system on which the tire is based, for example, the maximum air pressure in JATMA, maximum value listed in the “TIRE LOAD LIMITS AT VARIOUS COLD INFLATION PRESSURES” table in TRA, and “INFLATION PRESSURE” in ETRTO.

The term “standard tire load” refers to a tire load specified for the concerned tire by a standard included in a standardization system on which the tire is based, for example, the “maximum load capacity” in JATMA, maximum value listed in “TIRE LOAD LIMITS AT VARIOUS COLD INFLATION PRESSURES” table in TRA, and “LOAD CAPACITY” in ETRTO.

In each of the first crown blocks 6, the first block wall surface 15 has an outer end (15e) in the tire axial direction positioned at a distance (Lb) from the tire equator (C) in the tire axial direction and the distance (Lb) is in the range from 40% to 60% of the tread width TW. The outer end (15e) of the first block wall surface 15 is provided with the chamfered portion 20. Therefore, the anti-wear performance is maintained high.

The crown grooves 9 include a plurality of crown lateral grooves 10 extending in the tire axial direction to connect between the first shoulder circumferential grooves 3, and a plurality of crown joint grooves 11 each connecting a pair of the crown lateral grooves 10 adjacent to each other in a tire circumferential direction. Each of the crown lateral grooves 10 extends in a zigzag manner, for example. The crown joint grooves 11 in the present embodiment include first crown joint grooves 11A each extending linearly on the tire equator (C) and second crown joint grooves 11B each shifted from the tire equator (C) in the tire axial direction and extending in an L-shape.

The first crown blocks 6 in the present embodiment include laterally long blocks 6A each having a circumferential length smaller than an axial length thereof, and vertically long blocks 6B each having a circumferential length larger than an axial length thereof. The laterally long blocks 6A and the vertically long blocks 6B are arranged alternately in the tire circumferential direction, for example. The first crown block 6 shown in FIG. 2 is the vertically long block 6B.

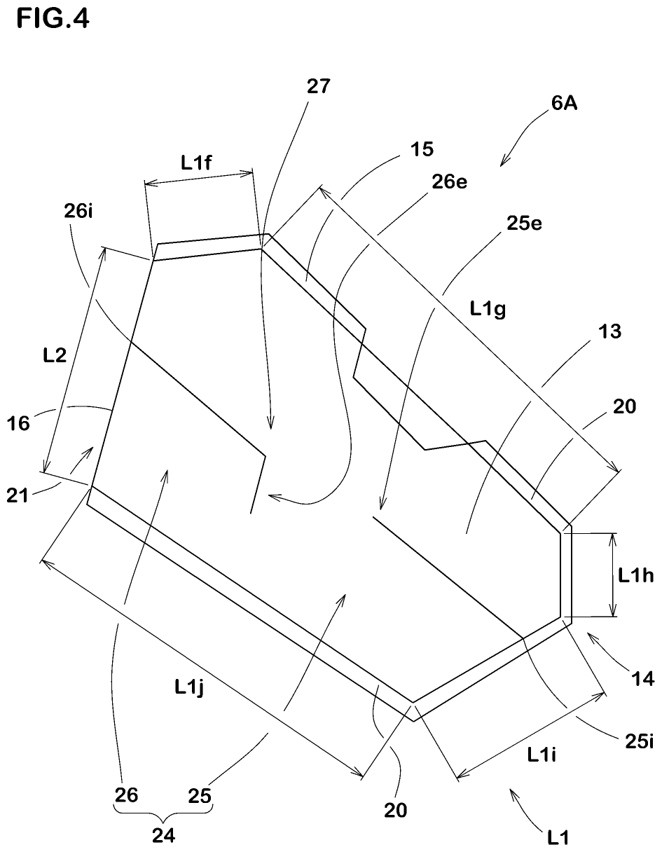

FIG. 4 is a plan view of one of the laterally long blocks 6A. As shown in FIGS. 2 and 4, each of the laterally long blocks 6A and the vertically long blocks 6B in the present embodiment is provided with the chamfered portion 20 at 50% or more of the length L1 of the first block wall surface 15. Each of the laterally long blocks 6A and the vertically long blocks 6B is provided with the chamfered portion 20 preferably in the range of 85% or more of the length L1, and more specifically, it is even more preferred that the chamfered portion 20 is provided in the range of 100% of the length L1. Further, each of the laterally long blocks 6A and the vertically long blocks 6B in the present embodiment has the second block wall surface 16 formed only by the wall surface main body 21 without the chamfered portion 20 formed thereon. As shown in FIG. 4, the length L1 of the first block wall surface 15 of each of the laterally long blocks 6A is the sum of a length L1g, a length L1h, a length L1i, and a length L1j. The first block wall surface 15 and the second block wall surface 16 of each of the laterally long blocks 6A have a radial cross-sectional shape shown in FIGS. 3A and 3B respectively, for example.

As shown in FIG. 1, each of the laterally long blocks 6A is demarcated by the crown lateral grooves 10 adjacent to each other in the tire circumferential direction, one of the first shoulder circumferential grooves 3, and one of the first crown joint grooves 11A. Each of the vertically long blocks 6B is demarcated by the crown lateral grooves 10 adjacent to each other in the tire circumferential direction, one of the first shoulder circumferential grooves 3, and one of the second crown joint grooves 11B.

As shown in FIG. 4, each of the laterally long blocks 6A is provided with crown sipes 24. The crown sipes 24 include a first crown sipe 25 and a second crown sipe 26. The first crown sipe 25 has a first end (25i) connected with the first block wall surface 15 and a second end (25e) terminating within the ground contacting surface 13 to have a closed end. The term “closed end” means an end not connected with other sipes or grooves. The same applies hereinafter. The first crown sipe 25 extends linearly over the entire length thereof. The second crown sipe 26 has a first end (26i) connected with the second block wall surface 16 and a second end (26e) terminating within the ground contacting surface 13 to have a closed end. The second crown sipe 26 has a bent portion 27 bent at an obtuse angle between the first end and the second end. Thereby, the second crown sipe 26 is configured to have two linear portions connected at the bent portion 27. The laterally long blocks 6A configured as such exert a high edge effect and suppress a decrease in the block rigidity. In the present specification, a sipe refers to an incision having a width of less than 1.5 mm and is distinguished from a groove having a groove width of 1.5 mm or more.

As shown in FIG. 1, the crown blocks 5 include a plurality of second crown blocks 7 arranged axially inside the first crown blocks 6. Each of the second crown blocks 7 is arranged on the tire equator (C).

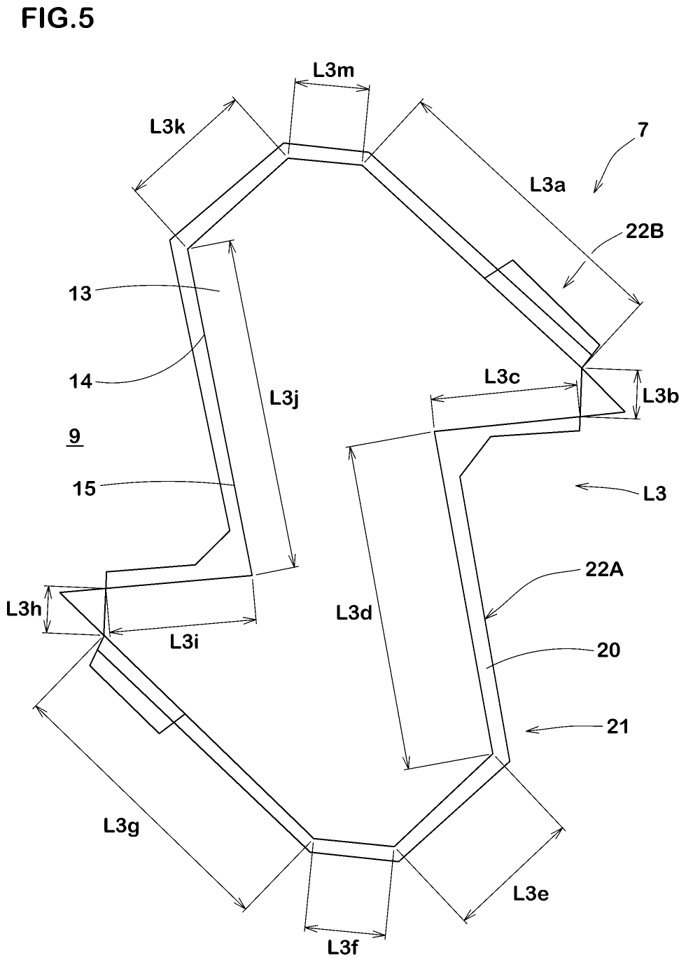

FIG. 5 is a plan view of one of the second crown blocks 7. As shown in FIG. 5, each of the second crown blocks 7 includes the ground contacting surface 13 and the block wall surface 14 extending radially inward from the ground contacting surface 13. The block wall surface 14 of each of the second crown blocks 7 is formed only by the first block wall surface 15 adjacent to one of the crown grooves 9. The block wall surface 14 of each of the second crown blocks 7 is provided with the chamfered portion 20 on the ground contacting surface 13 side in the range of 50% or more of a length L3 of the block wall surface 14 measured along the ground contacting surface 13. The second crown blocks 7 configured as such maintain the anti-wear performance even higher. The block wall surface 14 of each of the second crown blocks 7 has the chamfered portion 20 preferably in the range of 70% or more, and more preferably in the range of 85% or more of the length L3 of the block wall surface 14. In the present embodiment, the block wall surface 14 of each of the second crown blocks 7 has the chamfered portion 20 formed in the range of 100% of the length L3 of the block wall surface 14. In each of the second crown blocks 7, the length L3 of the block wall surface 14 is represented by the total sum of linearly extending portions, similar to the length L1 of the first block wall surface 15. In the case of the present embodiment, the length L1 is the sum of lengths (L3a) to (L3k) and a length (L3m). In FIG. 5, sipes disposed on the ground contacting surface 13 are omitted for convenience.

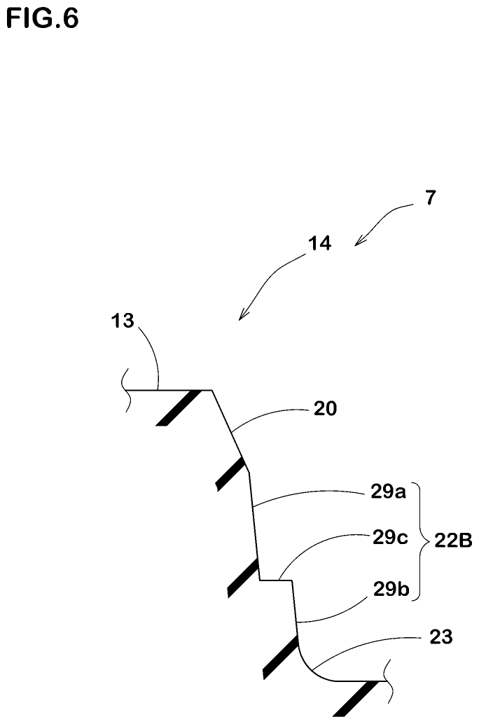

The block wall surface 14 of each of the second crown blocks 7 includes the chamfered portion 20 and the wall surface main body 21 extending radially inward from the chamfered portion 20. The wall surface main body 21 includes the linear portion 22 and the arcuate portion 23, for example. The linear portions 22 of the second crown blocks 7 include first portions 22A and second portions 22B. Each of the first portion 22A is formed similarly to the linear portion 22 of the first block wall surface 15 (shown in FIG. 3A). FIG. 6 is a radial cross section of one of the second portions 22B and a C-C cross sectional view of FIG. 1. As shown in FIG. 6, each of the second portions 22B includes an outer portion (29a) connected to the chamfered portion 20, an inner portion (29b) connected to the arcuate portion 23, and a joint portion (29c) connecting the outer portion (29a) and the inner portion (29b). The joint portion (29c) is formed with a gentler slope having an angle with respect to the tire radial direction larger than the outer portion (29a) and the inner portion (29b), for example. The joint portion (29c) is formed parallel to the ground contacting surface 13 in the present embodiment.

The first portions 22A are provided on the block wall surfaces 14 adjacent to the crown lateral grooves 10 and the block wall surfaces 14 adjacent to the second crown joint grooves 11B, for example. The second portions 22B are provided only in the block wall surfaces 14 adjacent to the crown lateral grooves 10, for example.

In the tread plan view, a total area of the chamfered portions 20 is preferably 1% or more, more preferably 2% or more, and preferably 5% or less, and more preferably 4% or less of a total area of the ground contacting surfaces 13 of the crown blocks 5. Therefore, the anti-wear performance is maintained effectively.

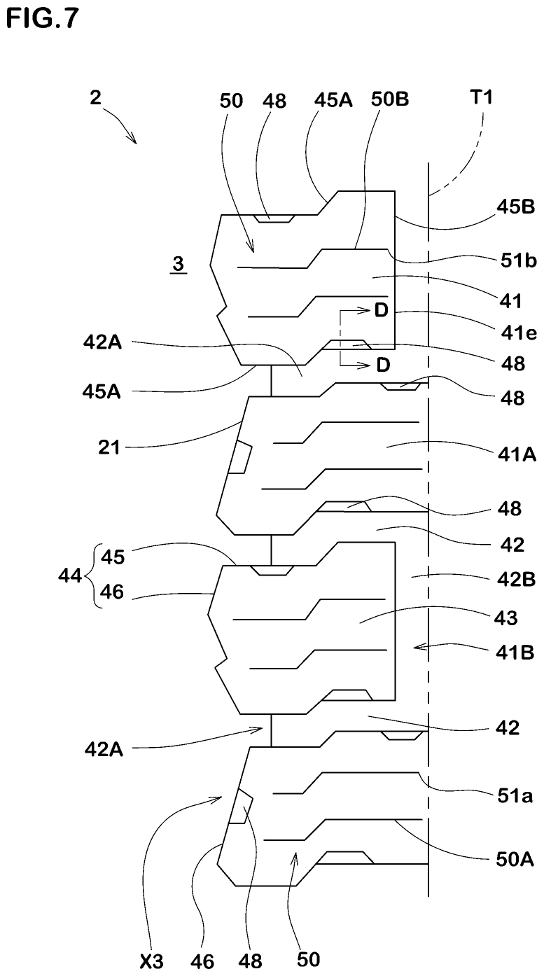

FIG. 7 is a plan view of the tread portion 2 outside the first shoulder circumferential groove 3 in the tire axial direction. As shown in FIG. 7, the tread portion 2 includes a plurality of shoulder blocks 41 arranged axially outside each of the first shoulder circumferential grooves 3 and a plurality of shoulder grooves 42 separating the shoulder blocks 41 from each other. Each of the shoulder grooves 42 extends axially outward from one of the first shoulder circumferential grooves 3.

Each of the shoulder blocks 41 includes a ground contacting surface 43 and a shoulder block wall surface 44 extending radially inward from the ground contacting surface 43. The shoulder block wall surface 44 includes third block wall surfaces 45 each adjacent to and facing a respective one of the shoulder grooves 42 and a fourth block wall surface 46 adjacent to and facing one of the first shoulder circumferential grooves 3.

The third block wall surfaces 45 are not provided with a chamfered portion on the ground contacting surface 43 side, for example. Further, the fourth block wall surface 46 does not have a chamfered portion on the ground contacting surface 43 side in the present embodiment. As a result, the on-snow performance is further improved. The third block wall surfaces 45 and the fourth block wall surface 46 are each formed of the wall surface main body 21 including the linear portion 22 and the arcuate portion 23 (shown in FIG. 3B) similar to the second block wall surface 16, for example. The third block wall surfaces 45 and the fourth block wall surface 46 are each formed only by the wall surface main body 21 in the present embodiment.

The shoulder grooves 42 include shoulder lateral groove portions 42A arranged in the tire circumferential direction and each extending from one of the first shoulder circumferential groove 3 to one of the first tread edges T1 adjacent thereto and shoulder longitudinal groove portions 42B each connecting the shoulder lateral groove portions 42A adjacent to each other in the tire circumferential direction, for example. Each of the shoulder longitudinal groove portions 42B extends on one of the first tread edges T1, for example.

The third block wall surfaces 45 include third lateral block wall surfaces 45A adjacent to the shoulder lateral groove portions 42A and third longitudinal block wall surfaces 45B facing the shoulder longitudinal groove portions 42B.

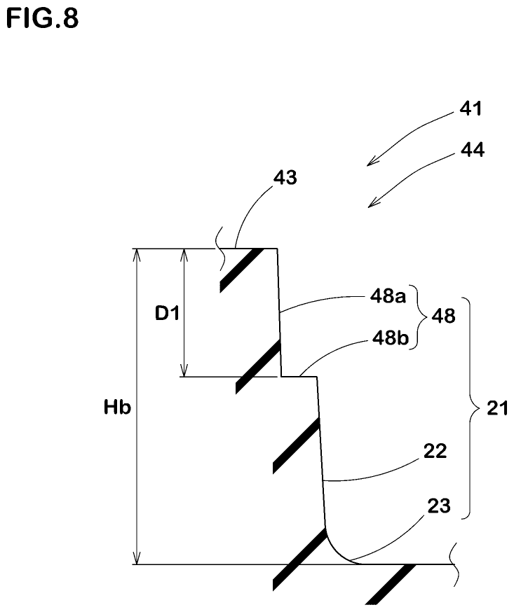

The shoulder block wall surfaces 44 include cutout portions 48 recessed toward inside of the ground contacting surface 43. It should be noted that the cutout portion 48 is recessed toward the center of the ground contacting surface 43 and recessed radially inward from the ground contacting surface 43 in the present embodiment, for example. FIG. 8 is a D-D cross sectional view of FIG. 7. As shown in FIG. 8, the cutout portion 48 is provided in the wall surface main body 21, for example. The wall surface main body 21 in the present embodiment includes the cutout portion 48, the linear portion 22, and the arcuate portion 23. Each of the cutout portions 48 includes a lateral facing surface (48a) extending radially inward from the ground contacting surface 43 and facing toward a groove center (groove center of the shoulder lateral groove portion 42A in this case) and an outward facing surface (48b) connected to the lateral facing surface (48a) and facing outward in the tire radial direction, for example. The cutout portions 48 configured as such increase the volume of snow to be sheared, therefore, the on-snow performance is further improved. The outward facing surface (48b) is connected to the linear portion 22, for example.

The cutout portions 48 are provided in the third lateral block wall surfaces 45A, for example. The cutout portions 48 are provided one on each third lateral block wall surface 45A, for example. The cutout portions 48 are also provided in the fourth block wall surfaces 46, for example. The cutout portions 48 are not provided in the third longitudinal block wall surfaces 45B in the present embodiment.

In the tread plan view, a total area of the cutout portions 48 is preferably 1% or more, more preferably 2% or more, and preferably 5% or less, and even more preferably 4% or less of a total area of the ground contacting surfaces 43 of the shoulder blocks 41. Since the total area of the cutout portions 48 is 1% or more of the total area of the ground contacting surfaces 43 of the shoulder blocks 41, the on-snow performance is improved when the external shapes of the shoulder blocks 41 are the same. Since the total area of the cutout portions 48 is 5% or less of the total area of the ground contacting surfaces 43 of the shoulder blocks 41, the anti-wear performance is maintained when the external shapes of the shoulder blocks 41 are the same.

A depth D1 of each of the cutout portions 48 is preferably 10% or more, more preferably 20% or more, and preferably 50% or less, and even more preferably 40% or less of a height (Hb) in the tire radial direction of each of the shoulder blocks 41. As a result, the on-snow performance is further improved while the anti-wear performance is maintained.

The shoulder blocks 41 in the present embodiment include first shoulder blocks 41A and second shoulder blocks 41B each having an axial length smaller than each of the first shoulder blocks 41A. Each of the first shoulder blocks 41A is demarcated by a pair of the shoulder lateral groove portions 42A, one of the first tread edges T1, and one of the first shoulder circumferential grooves 3. Each of the second shoulder blocks 41B is demarcated by a pair of the shoulder lateral groove portions 42A, one of the shoulder longitudinal groove portions 42B, and one of the first shoulder circumferential grooves 3. Each of the second shoulder blocks 41B has an axially outer end (41e) located axially inside a respective one of the first tread edges T1.

The shoulder blocks 41 of the present embodiment are provided with shoulder sipes 50. The shoulder sipes include first shoulder sipes 50A provided in the first shoulder blocks 41A and second shoulder sipes 50B provided in the second shoulder blocks 41B. Each of the first shoulder sipes 50A has an axially outer end (51a) terminating axially inside a respective one of the first tread edges T1 to have a closed end, for example. Each of the second shoulder sipes 50B has an axially outer end (51b) terminating to have a closed end within the ground contacting surface 43 without connecting to one of the shoulder longitudinal groove portions 42B, for example.

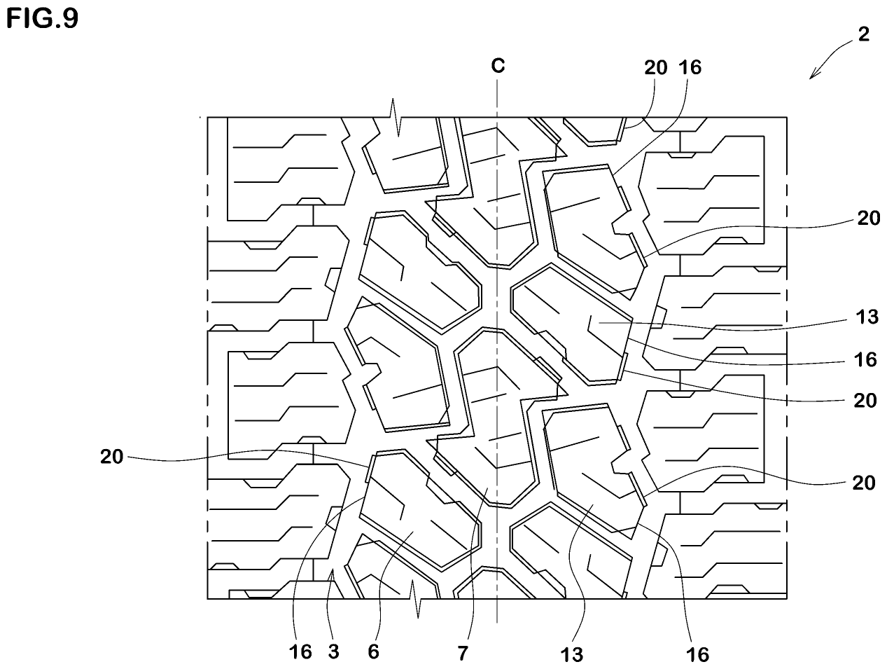

FIG. 9 is a plan view of the tread portion 2 according to another embodiment. The same reference numerals are assigned to configurations same as those of the previously described embodiment, and the descriptions thereof are omitted. As shown in FIG. 9, in each of the crown blocks in the tread portion 2 of this embodiment, the second block wall surface 16 is provided with the chamfered portion 20 formed on the ground contacting surface 13 side in the range from 35% to 45% of the length L2 of the second block wall surface 16 measured along the ground contacting surface 13. Even in the tire 1 configured as such, the on-snow performance is further improved while the anti-wear performance is maintained.

While detailed description has been made of an especially preferred embodiment of the present disclosure, the present disclosure can be embodied in various forms without being limited to the illustrated embodiment.

### STATEMENT OF DISCLOSURE

The present disclosure includes the following aspects.

### Present Disclosure 1

A tire including a tread portion wherein
the tread portion includes
a first tread edge,
a first shoulder circumferential groove adjacent to the first tread edge and arranged between the first tread edge and a tire equator,
a plurality of crown blocks arranged inside the first shoulder circumferential groove in a tire axial direction, and
a plurality of crown grooves arranged axially inside the first shoulder circumferential groove to separate the crown blocks from each other,
the crown blocks include a plurality of first crown blocks adjacent to the first shoulder circumferential groove,
each of the first crown blocks includes a ground contacting surface and a block wall surface extending inward in a tire radial direction from the ground contacting surface,
the block wall surface includes a first block wall surface adjacent to one of the crown grooves and a second block wall surface adjacent to the first shoulder circumferential groove,
the first block wall surface is provided with a chamfered portion on the ground contacting surface side in a range of 50% or more of a length of the first block wall surface measured along the ground contacting surface, and
the second block wall surface is either not provided with the chamfered portion on the ground contacting surface side or provided with the chamfered portion on the ground contacting surface side in a range of less than 50% of a length of the second block wall surface measured along the ground contacting surface.

### Present Disclosure 2

The tire according to Present Disclosure 1, wherein the first block wall surface is provided with the chamfered portion in the range of 100% of the length of the first block wall surface.

### Present Disclosure 3

The tire according to Present Disclosure 1 or 2, wherein
the first block wall surface includes a wall surface main body extending radially inward from the chamfered portion, and
a difference (θ1−θ2) between an angle θ1 of the chamfered portion with respect to a normal line of the ground contacting surface and an angle θ2 of the wall surface main body with respect to the normal line is 10 degrees or more and 30 degrees or less.

### Present Disclosure 4

The tire according to any one of Present Disclosures 1 to 3, wherein the chamfered portion has a length in the tire radial direction of 20% or more and 40% or less of a length in the tire radial direction of the block wall surface.

### Present Disclosure 5

The tire according to any one of Present Disclosures 1 to 4, wherein an angle θ1 of the chamfered portion with respect to a normal line of the ground contacting surface is 10 degrees or more and 30 degrees or less.

### Present Disclosure 6

The tire according to any one of Present Disclosures 1 to 5, wherein the tread portion further includes a plurality of shoulder blocks arranged axially outside the first shoulder circumferential groove and a plurality of shoulder grooves extending axially outward from the first shoulder circumferential groove to separate the shoulder blocks from each other,
each of the shoulder blocks includes a ground contacting surface and a shoulder block wall surface extending radially inward from the ground contacting surface,
the shoulder block wall surface includes a third block wall surface adjacent to one of the shoulder grooves and a fourth block wall surface adjacent to the first shoulder circumferential groove, and
the third block wall surface is not provided with the chamfered portion on the ground contacting surface side.

### Present Disclosure 7

The tire according to Present Disclosure 6, wherein the fourth block wall surface is not provided with the chamfered portion on the ground contacting surface side.

### Present Disclosure 8

The tire according to Present Disclosure 6 or 7, wherein
the shoulder block wall surface includes a cutout portion recessed toward inside of the ground contacting surface, and
the cutout portion has a depth in the tire radial direction of 10% or more and 50% or less of a height in the tire radial direction of the each of the shoulder blocks.

### Present Disclosure 9

The tire according to Present Disclosure 8, wherein a total area of the recessed portions of the shoulder block wall surfaces of the shoulder blocks is 1% or more and 5% or less of a total area of the ground contacting surfaces of the shoulder blocks in a tread plan view.

### Present Disclosure 10

The tire according to any one of Present Disclosures 1 to 9, wherein
the crown blocks include a plurality of second crown blocks arranged axially inside the first crown blocks,
each of the second crown blocks includes a ground contacting surface and a block wall surface extending radially inward from the ground contacting surface, and
in each of the second crown blocks, the block wall surface is provided with a chamfered portion on the ground contacting surface side in a range of 50% or more of a length of the block wall surface measured along the ground contacting surface.

### Present Disclosure 11

The tire according to Present Disclosure 10, wherein a total area of the chamfered portions of the crown blocks is 1% or more and 5% or less of a total area of the ground contacting surfaces of the crown blocks in a tread plan view.

### DESCRIPTION OF REFERENCE SIGNS

1 tire
3 first shoulder circumferential groove
6 first crown block
9 crown groove
13 ground contacting surface
14 block wall surface
15 first block wall surface
16 second block wall surface
20 chamfered portion
L1 length of first block wall surface
L2 length of second block wall surface

1. A tire comprising a tread portion wherein
the tread portion includes
a first tread edge,
a first shoulder circumferential groove adjacent to the first tread edge and arranged between the first tread edge and a tire equator,
a plurality of crown blocks arranged inside the first shoulder circumferential groove in a tire axial direction, and
a plurality of crown grooves arranged axially inside the first shoulder circumferential groove to separate the crown blocks from each other,
the crown blocks include a plurality of first crown blocks adjacent to the first shoulder circumferential groove,
each of the first crown blocks includes a ground contacting surface and a block wall surface extending inward in a tire radial direction from the ground contacting surface,
the block wall surface includes a first block wall surface adjacent to one of the crown grooves and a second block wall surface adjacent to the first shoulder circumferential groove,
the first block wall surface is provided with a chamfered portion on the ground contacting surface side in a range of 50% or more of a length of the first block wall surface measured along the ground contacting surface, and
the second block wall surface is either not provided with the chamfered portion on the ground contacting surface side or provided with the chamfered portion on the ground contacting surface side in a range of less than 50% of a length of the second block wall surface measured along the ground contacting surface.

2. The tire according to claim 1, wherein the first block wall surface is provided with the chamfered portion in the range of 100% of the length of the first block wall surface.

3. The tire according to claim 1, wherein
the first block wall surface includes a wall surface main body extending radially inward from the chamfered portion, and
a difference (θ1−θ2) between an angle θ1 of the chamfered portion with respect to a normal line of the ground contacting surface and an angle θ2 of the wall surface main body with respect to the normal line is 10 degrees or more and 30 degrees or less.

4. The tire according to claim 1, wherein the chamfered portion has a length in the tire radial direction of 20% or more and 40% or less of a length in the tire radial direction of the block wall surface.

5. The tire according to claim 1, wherein an angle θ1 of the chamfered portion with respect to a normal line of the ground contacting surface is 10 degrees or more and 30 degrees or less.

6. The tire according to claim 1, wherein
the tread portion further includes a plurality of shoulder blocks arranged axially outside the first shoulder circumferential groove and a plurality of shoulder grooves extending axially outward from the first shoulder circumferential groove to separate the shoulder blocks from each other,
each of the shoulder blocks includes a ground contacting surface and a shoulder block wall surface extending radially inward from the ground contacting surface,
the shoulder block wall surface includes a third block wall surface adjacent to one of the shoulder grooves and a fourth block wall surface adjacent to the first shoulder circumferential groove, and
the third block wall surface is not provided with the chamfered portion on the ground contacting surface side.

7. The tire according to claim 6, wherein the fourth block wall surface is not provided with the chamfered portion on the ground contacting surface side.

8. The tire according to claim 6, wherein
the shoulder block wall surface includes a cutout portion recessed toward inside of the ground contacting surface, and
the cutout portion has a depth in the tire radial direction of 10% or more and 50% or less of a height in the tire radial direction of the each of the shoulder blocks.

9. The tire according to claim 8, wherein a total area of the recessed portions of the shoulder block wall surfaces of the shoulder blocks is 1% or more and 5% or less of a total area of the ground contacting surfaces of the shoulder blocks in a tread plan view.

10. The tire according to claim 1, wherein
the crown blocks include a plurality of second crown blocks arranged axially inside the first crown blocks,
each of the second crown blocks includes a ground contacting surface and a block wall surface extending radially inward from the ground contacting surface, and
in each of the second crown blocks, the block wall surface is provided with a chamfered portion on the ground contacting surface side in a range of 50% or more of a length of the block wall surface measured along the ground contacting surface.

11. The tire according to claim 10, wherein a total area of the chamfered portions of the crown blocks is 1% or more and 5% or less of a total area of the ground contacting surfaces of the crown blocks in a tread plan view.

12. The tire according to claim 1, wherein the second block wall surface is not provided with the chamfered portion.

13. The tire according to claim 1, wherein
the first block wall surface has an outer end in the tire axial direction positioned at a distance from the tire equator in the tire axial direction, and
the distance is 40% or more and 60% or less of a tread width.

14. The tire according to claim 13, wherein the outer end of the first block wall surface is provided with the chamfered portion.

15. The tire according to claim 1, wherein
the first crown blocks include laterally long blocks each having a length in a tire circumferential direction smaller than a length in the tire axial direction thereof, and vertically long blocks each having a circumferential length larger than an axial length thereof, and
the laterally long blocks and the vertically long blocks are arranged alternately in the tire circumferential direction.

16. The tire according to claim 15, wherein
each of the laterally long blocks is provided with crown sipes,
the crown sipes include a first crown sipe and a second crown sipe,
the first crown sipe extends linearly and has a first end connected with the first block wall surface and a second end terminating within the ground contacting surface to have a closed end, and
the second crown sipe has a first end connected with the second block wall surface, a second end terminating within the ground contacting surface to have a closed end, and a bent portion bent at an obtuse angle.

17. The tire according to claim 1, wherein
the crown blocks further include a plurality of second crown blocks arranged axially inside the first crown blocks, and
the second crown blocks are arranged on the tire equator.

18. The tire according to claim 17, wherein
the crown grooves include a plurality of crown lateral grooves extending in the tire axial direction in a zigzag manner to separate the second crown blocks from each other and a plurality of crown joint grooves each connecting a pair of the crown lateral grooves adjacent to each other in a tire circumferential direction, and
the crown joint grooves include first crown joint grooves each extending linearly on the tire equator and second crown joint grooves each shifted from the tire equator in the tire axial direction and extending in an L-shape.

19. The tire according to claim 18, wherein
each of the second crown blocks includes a ground contacting surface and a block wall surface extending radially inward from the ground contacting surface,
in each of the second crown blocks,
the block wall surface includes a chamfered portion and a wall surface main body extending radially inward from the chamfered portion,
the wall surface main body includes a linear portion extending radially inward from the chamfered portion and an arcuate portion extending in an arc shape to connect the linear portion and a groove bottom of one of the crown grooves adjacent thereto,
the linear portion includes a first portion and a second portion,
the first portion extends linearly over an entire length thereof in the tire radial direction,
the second portion includes an outer portion connected to the chamfered portion, an inner portion connected to the arcuate portion, and a joint portion connecting the outer portion and the inner portion,
each of the outer portion, the inner portion, and the joint portion extends linearly, and
the joint portion is formed with a gentler slope having an angle with respect to the tire radial direction larger than the outer portion and the inner portion.

20. The tire according to claim 19, wherein
in the second crown blocks,
the first portions are provided in the block wall surfaces adjacent to the crown lateral grooves and the block wall surfaces adjacent to the second crown joint grooves, and
the second portions are provided only in the block wall surfaces adjacent to the crown lateral grooves.
